(19) United States
(12) Patent Application Publication
(10) Pub. No.: US 2007/0132794 A1
(43) Pub. Date: Jun. 14, 2007

(54) System and Method For Printing in Substrates

(75) Inventor: Richard John Baker, West Lebanon, NH (US)

Correspondence Address: FISH & RICHARDSON PC, P.O. BOX 1022, MINNEAPOLIS, MN, 55440-1022, US

(73) Assignee: FUJIFILM DIMATIX, INC., Lebanon, NH (US)

(21) Appl. No.: 11/552,206

(22) Filed: Oct. 24, 2006

Related U.S. Application Data
(60) Provisional application No. 60/729,940, filed on Oct. 25, 2005.

(51) Int. Cl. B41J 29/38

(52) U.S. Cl. 347/6

(57) ABSTRACT

Printing systems and method of printing on substrates are provided. A method of printing one or more images using a printhead, the method including moving a substrate on a transporter, providing a printhead configured to print a plurality of print lines in a direction, rotating an image to an image angle relative to the direction of the print lines, and printing the image rotated to an angle onto the substrate.

### CROSS-REFERENCE TO RELATED APPLICATIONS

This claims priority to U.S. Application Ser. No. 60/729,940, filed on Oct. 25, 2005.

### TECHNICAL FIELD

In general, this disclosure related to printing systems and methods of printing on substrates.

### BACKGROUND

Droplet ejection devices are used for depositing droplets on a substrate. Ink jet printers are a type of droplet ejection device. Ink jet printers typically include an ink supply to nozzle path. The nozzle path terminates in a nozzle opening from which ink drops are ejected. Ink drop ejection is controlled by pressurizing ink in the ink path with an actuator, which may be, for example, a piezoelectric deflector, a thermal bubble jet generator, or an electro statically deflected element. A typical printhead has an array of ink paths with corresponding nozzle openings and associated actuators, such that drop ejection from each nozzle opening can be independently controlled. In a drop-on-demand printhead, each actuator is fired to selectively eject a drop at a specific pixel location of an image as the printhead and a printing substrate are moved relative to one another. In high performance printheads, the nozzle openings typically have a diameter of 50 microns or less, e.g., around 35 microns, are separated at a pitch of 100-300 nozzle/inch, have a resolution of 100 to 3000 dpi or more, and provide drop sizes of about 1 to 70 picoliters or less. Drop ejection frequency can be 10 kHz or more.

Printing accuracy is influenced by a number of factors, including the size and velocity uniformity of drops ejected by the nozzles in the head and among multiple heads in a printer. The drop size and drop velocity uniformity are in turn influenced by factors such as the dimensional uniformity of the ink paths, acoustic interference effects, contamination in the ink flow paths, and the actuation uniformity of the actuators.

### SUMMARY

Generally, the invention relates to printing systems and methods of printing on substrates, In an aspect, a method of printing one or more images using a printhead, the method includes moving a substrate on a transporter, providing a printhead configured to print a plurality of print lines in a direction, rotating an image to an image angle (i.e., about 45 degrees) relative to the direction of the print lines,and printing the image rotated to an image angle onto the substrate.

Implementations may include one or more of the following features. The method can include moving the transporter to a transporter angle (i.e., about 45 degrees) relative to the printhead, the transporter angle substantially equals the image angle.

In another aspect, a method of printing one or more images on a substrate using a printhead, the method includes moving a substrate on a transporter in a direction, rotating at least two orifices on a printhead to an orifice angle (i.e., about 45 degrees) relative to the transporter, the printhead configured to print a plurality of print lines in a direction substantially parallel to the direction of the transporter, rotating an image to an image angel relative to the print lines, and printing the image rotated to an image angle.

Implementations can include one or more of the following features. The method can include orifices that are parallel it a side of the printhead, or orifices that are rotated to the orifice angle relative to a side of the printhead.

In an aspect, a printing system includes a printhead configured to print a plurality of print lines in a direction, a transporter for moving a substrate relative to the printhead, and an image rotated to an image angle (i.e., about 45 degrees) relative to the direction of the print lines, the printhead prints the image onto the substrate.

Implementations can include one or more of the following features. The printing system can include the transporter being rotated to a transporter angle relative to printhead and the transporter angle substantially equals the image angle. The printing system can include and image database for storing images, a digital imager for processing the image, or a computer network through which the image travels to the printhead. The system can also include an ink reservoir or a control unit to control functions. of the printhead, The printhead can include at least two orifices rotated to an orifice angle relative to the transporter. The orifices can be parallel to a side of the printhead or rotated to the orifice angle relative to a side of the printhead.

These printing systems and methods of printing create less noticeable jet-out artifacts. A jet-out artifact is a black space left through an image when a jet becomes inoperative and stops depositing ink. Also, when printing rotated images, if either the transporter or the orifices are rotated, the substrates may be printed closer together. Furthermore, printing rotated images increases jet sustainability. Since more jets are used to print rotated images than are used to print parallel or perpendicular images, it is less likely that jets will dry out or clog. If a jet dries out or clogs, a jet-out artifact may be left on the image.

### DESCRIPTION OF DRAWINGS

FIG. 1 is a block diagram of a printing system

FIG. 2a is a top view of an image on a substrate.

FIG. 2b is top view of a rotated image of FIG. 2a rotated on a substrate.

FIG. 3a is a top view of the image of FIG. 2a with a jet-out artifact.

FIG. 3b is a top view of the rotated image of FIG. 3a with a jet-out artifact.

FIG. 4 is a block diagram of a printing system with a printhead, a rotated image, and a rotated transporter.

FIGS. 5a & b are bottom views of a printhead with orifices parallel to a side of the printhead.

FIGS. 6a & b are bottom views of a printhead with orifices aligned at an angle relative to a side of the printhead.

FIG. 7 is a block diagram of a printing system with a printhead similar to FIG. 5b printing a rotated image on a substrate traveling along the transporter.

FIG. 8 is a block diagram of a printing system with a printhead similar to FIG. 6b printing a rotated image on a substrate traveling along the transporter.

### DETAILED DESCRIPTION

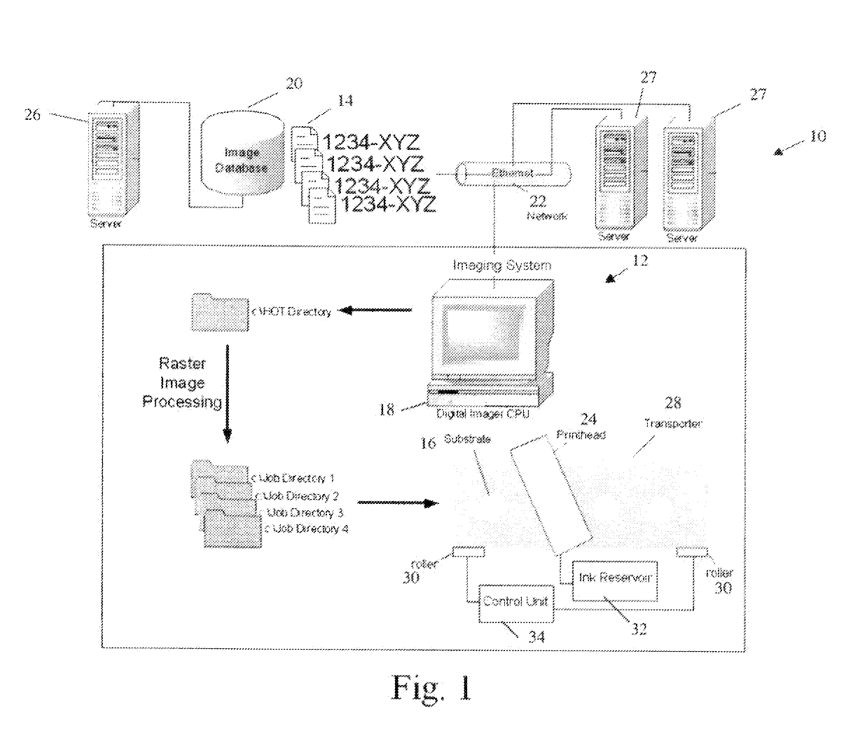

Referring to FIG. 1, a printing system 10 includes an imaging system 12 for printing one or more images 14 on a substrate 16. The imaging system 12 includes a digital imager 18 for processing images 14 stored in a image database 20 and provided to the digital imager 18 via a local area network 22. In other implementations, the images 14 can be delivered from the database via wide area network (e.g., Internet). The imaging system 12 converts an image 14 into a format compatible with a printhead 24. In this embodiment, the image database may include a library of images 14 stored on a server 26. Other servers 27 may be connected to the network 22 for storing and sending images 14.

More specifically, and discussed in greater detail below, digital imager 18 processes the images 14 by electronically rotating the image 14 relative to the print lines before sending the image 14 to a printhead 24. The printhead 24 prints the image 14 onto a substrate 16 traveling on the transporter 28, which in this embodiment includes a conveyor belt that moves along rollers 30. Additionally, the printing system 10 includes an ink reservoir 32 to store one or more inks, and in this embodiment, includes a control unit 34 for performing different functions, such as monitoring the ink level, managing data transfers, sensing a jet-out, or controlling the temperature of the ink.

The printing system 10 may print one image 14 on one substrate 16, or multiple images on one substrate 16. In a preferred embodiment, the printing system 10 prints one or more images 14 on multiple substrates 16 traveling along the transporter 28.

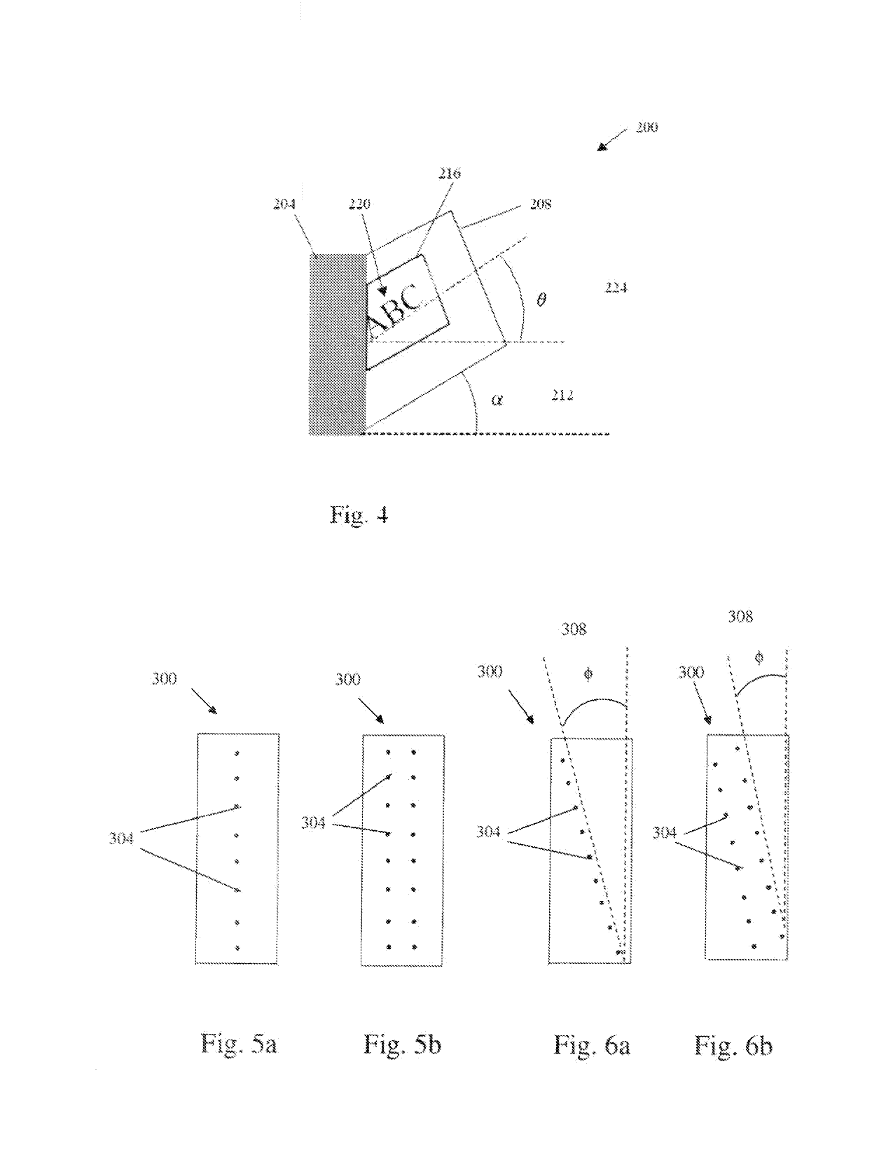

By rotating an image to be printed on a substrate, jet-out artifacts are less noticeable. If a jet dries out or clogs, a jet-out artifacts may be left on the image. A jet-out artifact is a blank space left through an image when a jet becomes inoperative an stops depositing ink (see FIGS. 3a and 3b below). For higher print resolution, an array of printhead orifices may be rotated (see FIGS. 6a and 6b below).

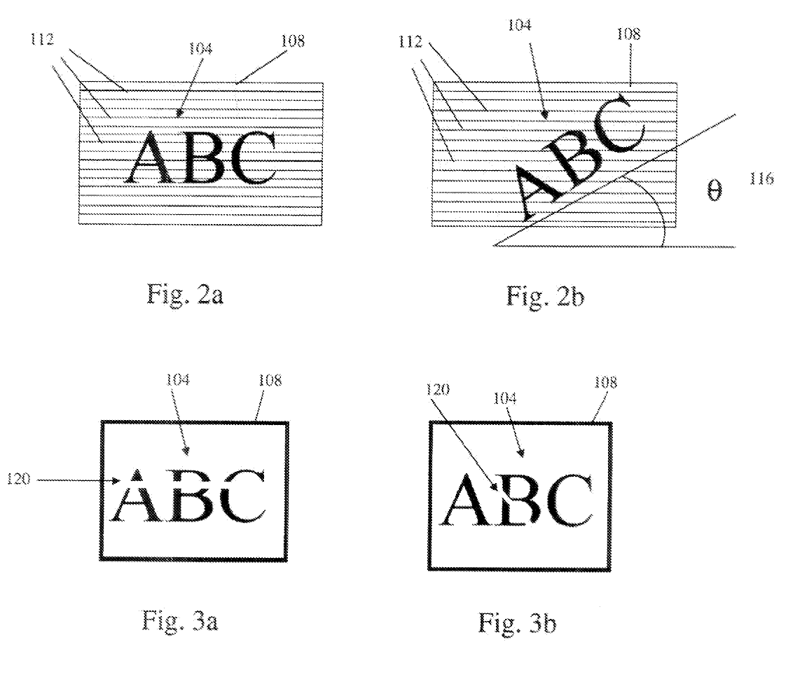

Referring to FIG. 2a, an image 104 is printed in a substrate 108, in this embodiment, and alphanumeric image (“ABC”) with the print lines 112 perpendicular to the image 104. In other embodiments, the print lines 112 parallel to the image 104.

Referring to FIG. 2b, an image 104 is rotated to an image angle θ 116 relative to the print lines 112. The image 104 is neither perpendicular nor parallel to the print lines 112. The image angle 116 may be between 0 and 90 degrees, preferably between 5 and 35 degrees or 55 and 85, more preferably between 35 and 55 degrees, 90 and 180 degrees, preferably between 95 and 125 degrees or 145 and 175, more preferably between 125, and 145 degrees; 180 and 270 degrees, preferably between 185 and 215 degrees or 235 and 265, more preferably between 215 and 235 degrees; or 270 and 360 degrees, preferably between 275 and 305 degrees or 325 and 355, more preferably between 305 and 325 degrees. In this embodiment, the image angle 116 is about 35 degrees relative to the print lines 112.

As shown in FIGS. 3a and 3b, when the image 104 is rotated to an angle, such that the image 104 is neither parallel nor perpendicular to the print lines (not shown), a jet-out artifact 120 is less noticeable to the human eye. For example, FIG. 3a shows an image 104 on a substrate 108, where the image 104 is perpendicular to the print lines (not shown). In FIG. 3a, a jet-out artifact 120 is more noticeable to the human eye because the jet-out may leave white space through the entire length of the image 104. Moreover, the human eye is more sensitive to horizontal and vertical lines, thus a horizontal or vertical jet-out artifact 120 is more noticeable.

In addition to less noticeable jet-out artifacts, printing rotated images increases jet sustainability. Since more jets are used to print rotated images than are used to print parallel or perpendicular images, it is less likely that jets will dry out or clog. For example, if rows of text are printed and the rows are parallel to the print lines, the jets corresponding to the spaces between the rows of text will not be used, On the other hand, if the rows of text are rotated to angle relative to the print lines, most, if not all, of the jets will be used because the spaces between the rows are no longer parallel to the print lines.

Conversely, in FIG. 3b, when the image 104 is rotated to an angle relative to the print lines (not shown), a jet-out artifact 120 is less noticeable. The jet-out artifact 120 may leave white space only through a portion of the image 104 on the substrate 108 rather than the entire length of the image 104. Also, the human eye is less sensitive to angled lines, and may not perceive the jet-out artifact 120. Thus, in one embodiment, the image is an image rotated such that it is neither parallel nor perpendicular relative to the print lines.

FIG. 4 depicts a printing system 200 including a printhead 204, transporter 208 rotated to a transporter angle α 212, and a substrate 216 with and image 220 rotated to an angle θ 224. As shown in FIG. 4, for substrates 216 with an orientation (i.e., business cards), the transporter 208 may be rotated such that the rotated image 220 aligns with the orientation of the substrate 216. In one embodiment, the transporter angle 212 substantially equals the image angle 224. In one embodiment, the transporter angle 212 and image angle 224 are about 45 degrees. For other applications, the transporter angle 212 may by different from the image angle 224. In some embodiments, the transporter angle 212 and image angle are between 0 and 90 degrees, preferably between 5 and 35 degrees or 55 and 85, more preferably between 35 and 55 degrees; 90 and 180 degrees, preferably between 95 and 125 degrees or 145 and 175, more preferably between 125 and 145 degrees; 180 and 270 degrees, preferaly between 185 and 215 degrees or 235 and 265, more preferably between 215 and 235 degrees; or 270 and 360 degrees, preferably between 275 and 305 degrees or 325 and 355, more preferably between 305 and 325 degrees.

In FIG. 5a, an embodiment of a printhead 300 has a single row of orifices 304 aligned parallel to a side of the printhead 300. In another embodiment, as depicted in FIG. 5b, a printhead 300 may have multiple rows of orifices 304 parallel to a side of the printhead 300.

Referring to FIGS. 6a and 6b, to achieve higher print resolution, a printing system 200 may have orifices on a printhead 204 rotated to an orifice angle. FIGS. 6a and 6b show printheads 300 with orifices 304 that are aligned at an orifice angle φ 304 relative to a side of the printhead 300. In FIG. 6a, a printhead 300, while FIG. 5b depicts a printhead 300 with multiple rows of rotated orifices 304.

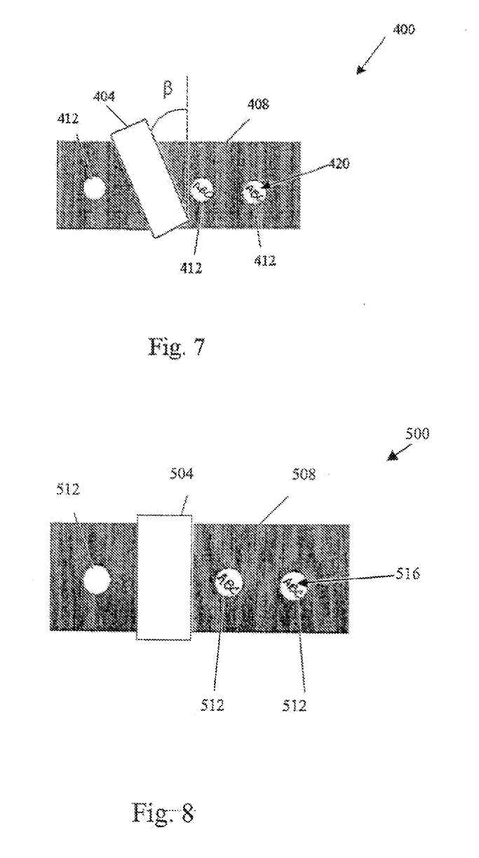

FIG. 7 shows a printing system 400 with a printhead 404, a transporter 408, and substrates 412 traveling along the transporter 408. The printhead 404 with parallel orifices as shown in FIG. 5b is rotated to an angle, such that the orifices are at an orifice angle β 416.

Similarly, the printing system 500 in FIG. 8 shows a printhead 504, a transporter 508, and substrates 512 traveling along the transporter 508. FIG. 8 uses the printhead 504 of FIG. 6b, in which the orifices are rotated to an angle φ on the printhead 504 and an image 516 is rotated. In one embodiment, the printhead 504 is placed perpendicular to the transporter 508. In another embodiment, the printhead 504 may be rotated relative to the transporter 508, such that both the printhead 504 and the orifices are rotated.

In some embodiments of FIG. 7 or 8, the orifice angle and image angle are between 0 and 90 degrees, preferably between 5 and 35 degrees or 55 and 85, more preferably between 35 and 55 degrees; 90 and 180 degrees; preferably between 95 and 125 degrees or 145 and 175, more preferably between 125 and 145 degrees; 180 and 270 degrees, preferably between 185 and 215 degrees, or 235 and 265, more preferably between 215 and 235 , degrees; 270 and 360 degrees, preferably between 275 and 305 degrees or 325 and 355, more preferably between 305 and 325 degrees.

In some embodiments of FIG. 7 or 8, the printing system may print rotated images on a paper web that are cut out of the paper web, such as business cards or wrappers. Similarly, in other embodiments, the printing system may print rotated images on one or more sheets of food products, like confectionery or dough, which are subsequently cut into smaller pieces.

Other embodiments are within the scope of the claims. For example, although printing system is shown having one imaging system, in other applications, a number of imaging systems associated with the same or different transporter may by connected to the computer network.

The printing systems may be used to print on substrates of any shape, such as round, rectangular, planar, or nonplanar. Some types of substrates may include food products, such as confectionery, gum, cookies, crackers, yogurt, ice cream, and pastries. Other substrates may include paper products, such as envelopes, stationery, business cards, as well as foil wrappers, candy wrappers, food packaging, textiles, plastic products, or round shaped objects, like golf balls. Also, the substrate may be a paper web. The images printed on the substrates may be text, graphic, or any combination thereof.

Other embodiments may use other printing systems, such as rotary printing, drum printing, thermal bubble jet printing, continuous ink jet, laser printing, and helical printing.

Referring to FIG. 7, the printing system 400 may include a sensor (not shown) that detects the edge of a substrate 412, at which time the sensor signals the printhead 404 to start printing. If substrates 412 are being printed close together, the printhead 404 may abruptly stop printing on a first substrate when the sensor detects the second substrate, leaving an incomplete image on the first substrate. In such circumstances, software can be used to overlay consecutive images to move the images closer together. The printhead can then continue printing the first substrate after the sensor signals the printhead to start printing the second substrate.

Before the images are rotated, they have a rectangular orientation. The images are then rotated and have a skewed rectangular orientation. To make the images rectangular for bitmap rasterization, the skewed regions are filled with zeros. These skewed regions cause the consecutive images to be further apart and make it difficult to print on substrates close together on a conveyor. To move the images closer together, the images are overlaid and combined by “or” logic function. For example, image 2 overlays image 1 and covers a few pixels of image 1. The “or” logic function ensures that the pixels in image 1 that are overlaid by image 2 will still be printed. The images can also be slanted after they are rotated, which permits the images to be overlaid even closer together.

What is claimed is:

1. A method of printing one or more images using a printhead, the method comprising:
moving a substrate on a transporter;
providing a printhead configured to print a plurality of print lines in a direction;
rotating an image to an image angle relative to the direction of the print lines; and
printing the image rotated to an image angle onto the substrate.

2. The method of claim 1, further comprising moving the transporter to a transporter angle relative to the printhead, the transporter angle substantially equals the image angle.

3. The method of claim 1, wherein the transporter angle is about 45 degrees.

4. The method of claim 1, wherein the image angle is about 45 degrees.

5. A method of printing one or more images on a substrate using a printhead, the method comprising:
moving a substrate on a transporter in a direction;
rotating at least two orifices on a printhead to an orifice angle relative to the transporter, the printhead configured to print a plurality of print lines in a direction substantially parallel to the direction of the transporter;
rotating an image to an image angle relative to the print lines; and
printing the image rotated to an image angle.

6. The method of claim 5, wherein the orifices are parallel to a side of the printhead.

7. The method of claim 5, wherein the orifices are rotated to the orifice angle relative to a side of the printhead.

8. The method of claim 5, wherein the orifice angle is about 45 degrees.

9. The method of claim 5, wherein the image angle is about 45 degrees.

10. A printing system comprising:
a printhead configured to print a plurality of print lines in a direction;
a transporter for moving a substrate relative to the printhead; and
an image rotated to an image angle relative to the direction of the print lines, the printhead prints the image onto the substrate.

11. The printing system of claim 11, wherein the transporter being rotated to a transporter angle relative to the printhead and the transporter angle substantially equals the image angle.

12. The printing system of claim 11, further comprising an image database for storing images.

13. The printing system of claim 11, further comprising a digital imager for processing the image.

14. The printing system of claim 11, further comprising a computer network through which the image travels to the printhead.

15. The printing system of claim 11, further comprising an ink reservoir.

16. The printing system of claim 11, further comprising a control unit to control functions of the printhead.

17. The printing system of claim 11, wherein the printhead includes at least two orifices rotated to an orifice angle relative to the transporter.

18. The printing system of claim 17, wherein the orifices are parallel to a side of the printhead.

19. The printing system of claim 17, wherein the orifices are rotated to the orifice angle relative to a side of the printhead.

20. The printing system of claim 11, wherein the image angle is about 45 degrees.
